(19) United States
(12) Patent Application Publication
(10) Pub. No.: US 2012/0156896 A1
(43) Pub. Date: Jun. 21, 2012

(54) PIN ADAPTER WITH LED

(76) Inventors: Jerry Corless, Streetsboro, OH (US); Gregory Rotenberg, Highland Heights, OH (US)

(21) Appl. No.: 13/095,344

(22) Filed: Apr. 27, 2011

Related U.S. Application Data
(60) Provisional application No. 61/424,032, filed on Dec. 16, 2010.

(51) Int. Cl. H01R 33/00

(52) U.S. Cl. 439/35

(57) ABSTRACT

A pin adapter to connect a master electrical system of a towing vehicle with a subservient electrical system of a towed vehicle is disclosed. In particular, the pin adapter allows for connection of a different master electrical interface with a different subservient electrical interface. The pin adapter may include a body, the body having a first electrical interface capable of electrically engaging the electrical system of the towing vehicle, and a second electrical interface capable of electrically engaging the electrical system of the towed vehicle. The second electrical interface may include a plurality of terminals. The pin adapter may further include a cover attached to the body, the cover capable of engaging only one of the plurality of terminals of the second electrical interface.

### CROSS-REFERENCE TO RELATED APPLICATION

This application claims benefit from U.S. Provisional Patent Application No. 61/424,032, entitled “Pin Adapter with LED,” filed on Dec. 16, 2010, which is hereby incorporated in its entirety by reference.

### FIELD OF INVENTION

The present invention generally relates to an electrical interface device and, more particularly, to an electrical pin adapter device.

### BACKGROUND

Cars, trucks and other vehicles are frequently used to pull or tow different types of towed vehicles or trailers for various purposes. These towed vehicles or trailers may generally be provided with electrical features, such as lights, brakes, etc., that may receive power through an electrical connection with the electrical system of the towing vehicle. To that end, it may be necessary to interconnect the brake lights, turn signal indicators, running lights, and the like, of the towing vehicle with the corresponding lights on the towed vehicle or trailer.

More specifically, it may be necessary to interconnect the electrical system of the towing vehicle with that of the towed vehicle to control the corresponding electrical systems of the towing and towed vehicles. For example, when the brake lights on the towing vehicle are lit, the brake lights on the towed vehicle are simultaneously lit. Similarly, when the turn signal on the towing vehicle is illuminated the corresponding turn signal on the towed vehicle is illuminated. The same may apply to backup lights of the two vehicles.

In order to accomplish this, however, the electrical system of the towing vehicle must interconnect with the electrical system of the towed vehicle. Towing vehicles and towed vehicles, however, may have different electrical configuration connections, which can make it difficult to electrically attach a particular towed vehicle with a particular towing vehicle.

Typically, the wiring harness or electrical connector of each vehicle may have an array of blades, pins, slots, or receptacles. These slots or receptacle may receive pins or blades, whereas the pins or blades may be inserted into corresponding slots or receptacles. The configurations of the electrical connector of the towing vehicle may not match the electrical configuration of the towed vehicle, which may preclude the two systems from being interconnected. An electrical interface device may be used to accommodate the different types of towed vehicle electrical connectors. There are, however, limitations on the available configurations.

Therefore, there is a need in the art for an improved electrical interface device, such as a pin adapter, that may accommodate different types of towed vehicle electrical connectors, all without any modification of the pin adapter. The pin adapter may provide an improved interface for quick and easy connections between the electrical systems of the towing vehicle and the towed vehicle.

### SUMMARY

A pin adapter for attaching an electrical system of a towing vehicle with an electrical system of a towed vehicle is disclosed. The pin adapter may comprise a body, the body having a first electrical interface capable of electrically engaging the electrical system of the towing vehicle and a second electrical interface capable of electrically engaging the electrical system of the towed vehicle. The second electrical interface may include a plurality of terminals. The pin adapter may further include a cover attached to the body, the cover capable of engaging only one of the plurality of terminals of the second electrical interface.

Further, a pin adapter may comprise a body having a first electrical interface having a plurality of terminals. The pin adapter may further include a first cover capable of encasing an entirety of the plurality terminals, and a second cover capable of encasing only a single one of the plurality of terminals.

Finally, a pin adapter capable of attaching a master electrical system of a towing vehicle having a first electrical configuration with a subservient electrical system of a towed vehicle having a second electrical configuration is disclosed. The pin adapter may include a first electrical interface electrically engaging the master electrical system and a second electrical interface electrically engaging the subservient electrical system, at least first and second electrical interconnections between the first and second electrical interfaces, where the at least first and second electrical interconnections are different, and an actuator capable of selectively changing the first electrical interconnection to the second electrical interconnection.

### DESCRIPTION OF THE DRAWINGS

The invention may be better understood by reference to the following detailed description taken in connection with the following illustrations, wherein:

FIG. 1 is a perspective view of an embodiment of a pin adapter.

FIG. 2 is a front view of the pin adapter.

FIG. 3 is a rear view of the pin adapter with a cover in phantom.

FIG. 4 is a first side view of the pin adapter.

FIG. 5 is a second side view of the pin adapter.

FIG. 6 is a top view of the pin adapter.

FIG. 7 is a bottom view of the pin adapter with a switch in a first position.

FIG. 7A is a bottom view of the pin adapter with a switch in a second position.

FIG. 8 is a wire diagram of an exemplary embodiment of electrical interfaces and a switch of embodiments of the pin adapter.

FIG. 9 is an electrical schematic layout of an exemplary embodiment of a circuit continuity tester of embodiments of the pin adapter.

FIG. 10 is a perspective view of an embodiment of a pin adapter in a non-limiting example attached to a towing vehicle.

FIG. 11 is a rear view of an embodiment of a pin adapter with a cover in phantom.

FIG. 12 is a rear view of an embodiment of a pin adapter with an exploded view of a cover in two alternative positions.

FIG. 13 is a side view of an embodiment of a pin adapter with a corresponding plug attached thereto.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

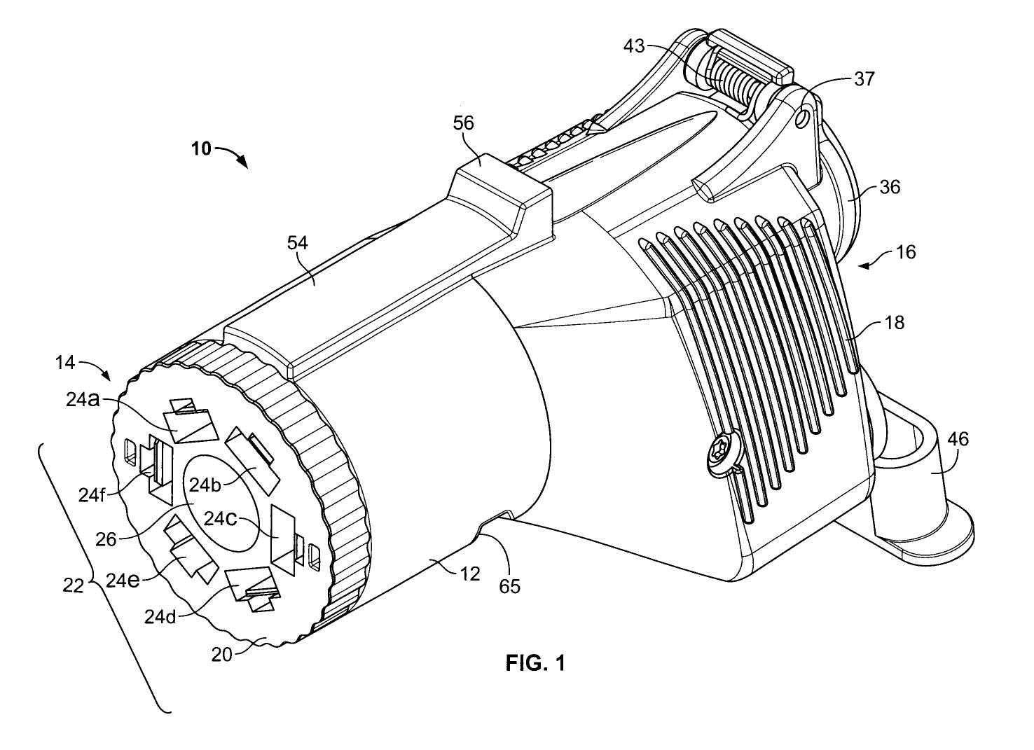

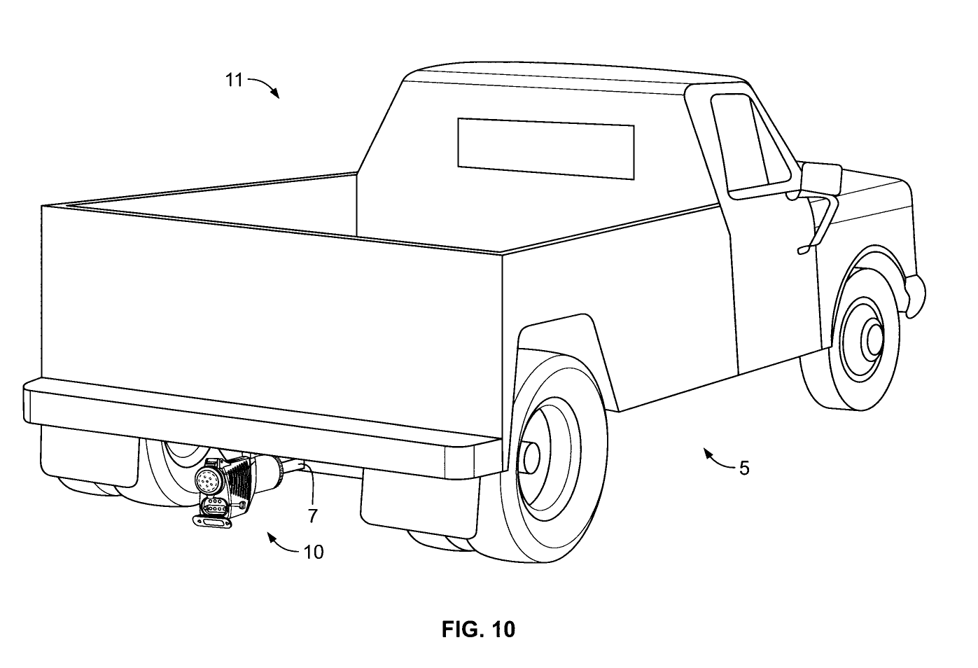

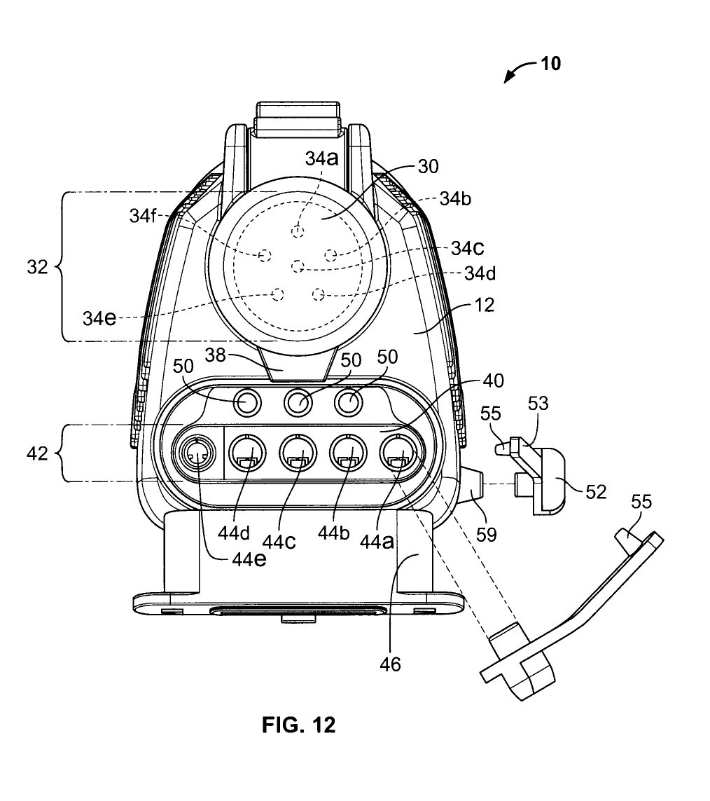

A pin adapter 10 is illustrated in FIGS. 1-13. The pin adapter 10 may be used in conjunction with a variety of towing vehicles and towed vehicles/trailers, such as recreational vehicles, tractor-trailers, boat trailers, livestock trailers, and cargo trailers, or the like. The pin adapter 10 may be positioned at any appropriate location on the towing vehicle 11, an example of which is shown in FIG. 10, and towed vehicle or trailer (not shown). For example, the pin adapter 10 may be mounted on a bumper of the towing vehicle 11, or if the towing vehicle is equipped with a hitch 7, the pin adapter 10 may be mounted on the hitch 7. The pin adapter 10 may be attached to the towing vehicle 11 by any appropriate means, such as with fasteners, ties, or the like. As an alternative, the pin adapter 10 may be selectively attachable to the towing vehicle 11, whereby the pin adapter 10 is not required to be mounted to any particular location. For example, the pin adapter 10 may be capable of being mounted under the bumper, on a hitch mount, on the rear of the towing vehicle 11, or at any other appropriate location.

The pin adapter 10 may be capable of accepting any appropriate number of or variety of different connectors that may be associated with the electrical systems of different types of towing and towed vehicles, without any modification to the pin adapter 10. The pin adapter 10 may be of any appropriate shape and size, such as a generally circular, rectangular or a combination of shapes, not just that shown in the exemplary embodiments herein. The pin adapter 10 may be ergonomically compact, yet of a design that accommodates the towing vehicle 11 towing a towed vehicle or trailer having a different connector. The pin adapter 10 may also be constructed from any appropriate type of material. In particular, the pin adapter 10 may be used to connect a master electrical system of a towing vehicle 11 with a subservient electrical system of a towed vehicle to operate the electrical systems of the towed vehicle. In many situations, the master electrical interface may not match that of the subservient electrical interface (i.e., the subservient electrical interface is different from the master electrical interface). The pin adapter 10 allows for connection of the master electrical interface with the non-matching/different subservient electrical interface.

The pin adapter 10 may include a body 12 having a first end 14 and a second end 16. The body 12 may be of any appropriate shape or size, such as generally circular, rectangular or a combination of shapes. The body 12 may include gripping features 18, such as ribs, an example of which is shown in FIG. 1. The rib features 18 may be located at any appropriate position on the body 12, such as adjacent the second end 16. The rib features 18 may be of any appropriate shape or size, such as a generally elongated shape. The rib features 18 may also be slightly raised above the surface of the body 12. In addition, there may be any appropriate number of rib features 18. The rib features 18 may aid the user in placing or removing the adapter 10 from the towing vehicle 11 or trailer, by for example, making it easier to hold and grip.

In an exemplary embodiment shown, the pin adapter 10 may include a first electrical interface 20, a second electrical interface 30, and a third electrical interface 40, see FIGS. 1-3 and 11-12. The interfaces 20, 30, 40, in the exemplary embodiment, may provide the pin adapter 10 with the appropriate electrical connection(s) between the electrical systems of the towing vehicle 11 and towed vehicle. While the pin adapter 10 may be shown and described as having three electrical interfaces 20, 30, 40, it is to be understood that the pin adapter 10 may have any appropriate number of interfaces and should not be limited to that shown and described herein. For example, the pin adapter 10 may include two, three, four, five or more electrical interfaces. While any number of electrical interfaces may be used, the exemplary embodiment showing three such electrical interfaces will be described.

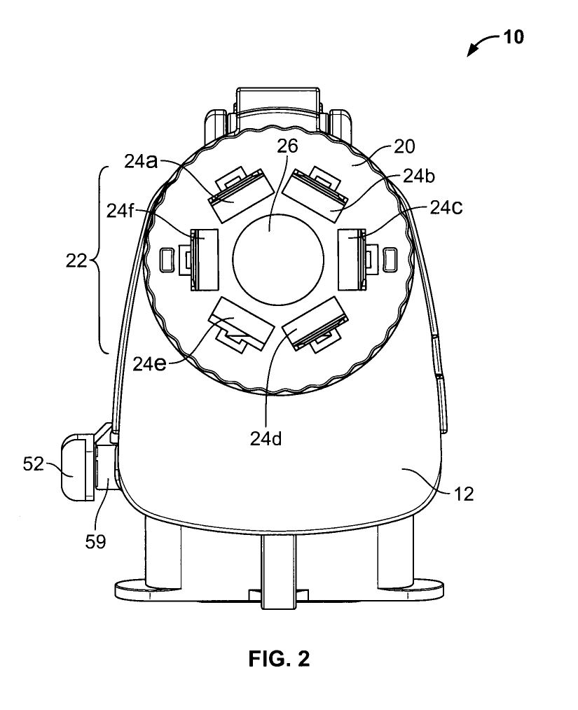

The first electrical interface 20 may be located at any appropriate position on the adapter 10, such as at the first end 14, as shown in FIGS. 1 and 2. The first interface 20 may be configured to be coupled to the master electrical interface of the towing vehicle 11 and may include a first set of terminals 22. The first set of terminals 22 may include at least one terminal 24; however, there may be any appropriate number of terminals 24, such as four, six, seven, etc. The terminals 24 may be of any appropriate shape, size, or type. For example, the terminals 24 may be flat or blade type terminals, pin-type terminals, etc. The terminals 24 may be in any appropriate type of arrangement or configuration, such as in a generally circular arrangement. Each terminal 24 may correspond to a certain function, such as providing a signal for controlling the tail lights, left turn signal, right turn signal, brake lights, electric brake control circuit, back-up/auxiliary, battery voltage, and the like from the corresponding master electrical system of the towing vehicle 11 to the subservient electrical system of the towed vehicle. This results in the user of the towing vehicle 11 only having to operate the function on the towing vehicle 11 to operate the corresponding function on the towed vehicle.

More specifically, the first set of terminals 22 may be a six-way terminal, which is shown in FIGS. 1 and 2 as a blade terminal, in which one terminal 24d may connect ground, a second terminal 24c may connect the left turn control, a third terminal 24f may connect the right turn control, a fourth terminal 24b may connect the tail light control, a fifth terminal 24e may connect the electric brake control circuit, a sixth terminal 24a may connect the battery/auxiliary control to the towed vehicle.

Alternatively, the first set of terminals 22 may be a seven-way terminal (not shown). In this configuration, the first set of terminals include the terminals 24a-24f from the six-way terminal described above, but also include a seventh pin terminal (not shown), which connects an auxiliary/backup control to the towed vehicle.

In yet another alternative embodiment, the first set of terminals 22 may be a five-way terminal (not shown) in which one terminal 24a may connect ground, a second terminal 24b may connect the left turn control, a third terminal 24c may connect the right turn control, a fourth terminal 24d may connect the tail light control, and a fifth terminal 24e may connect the electric brake control circuit to the towed vehicle. In this embodiment, the terminals 24a-24e may be arranged in a linear orientation (not shown) as known in the industry, alternatively may be arranged in a substantially circular orientation, or may be arranged in any other appropriate configuration. However, in this embodiment, the electric brake connection results in the deactivation of the electric brake and operation of a back-up light. This is useful for boat trailers that require to be backed down a ramp into the water. It should be understood, however, that many other variations may be used without departing from the present invention.

The first interface 20 may also include an aperture 26. The aperture 26 may be of any appropriate shape or size, such as a generally circular, ovular, or rectangular shape. The aperture 26 may be located at any appropriate position on the first interface 20, such as at the approximate center of the first interface 20. The aperture 26 may be located at the approximate center of the terminals 24a-24f, whereby the terminals 24 may be located radially around the aperture 26. The aperture 26 may house a central auxiliary pin (not shown) or alternatively may just be a cavity with no auxiliary pin. In the embodiment in which the aperture 26 is an auxiliary pin (not shown) it may act as a backup circuit for the first set of terminals 22.

The second electrical interface 30 may be located at any appropriate position on the adapter 10, such as at the second end 16. The second interface 30 may include a second set of terminals 32. The second set of terminals 32 may include at least one terminal 34, however, there may be any appropriate number of terminals 34, such as four, six, seven, etc. The terminals 34 may be of any appropriate shape, size, or type. For example, the terminals 34 may be generally cylindrical in shape such as male and/or female pin terminals. Alternatively, the terminals 34 may be flat or blade types. The terminals 34 may be in any appropriate type of arrangement or configuration, such as in a generally circular arrangement, a linear arrangement, or the like. Each terminal 34 may correspond to a certain function, such as providing a signal for controlling the tail lights, left turn signal, right turn signal, brake lights, brake circuit, back-up/auxiliary, battery voltage, and the like from the corresponding master electrical system of the towing vehicle 11 to the subservient electrical system of the towed vehicle. This results in the user of the towing vehicle 11 only having to operate the function on the towing vehicle 11 to operate the corresponding function on the towed vehicle.

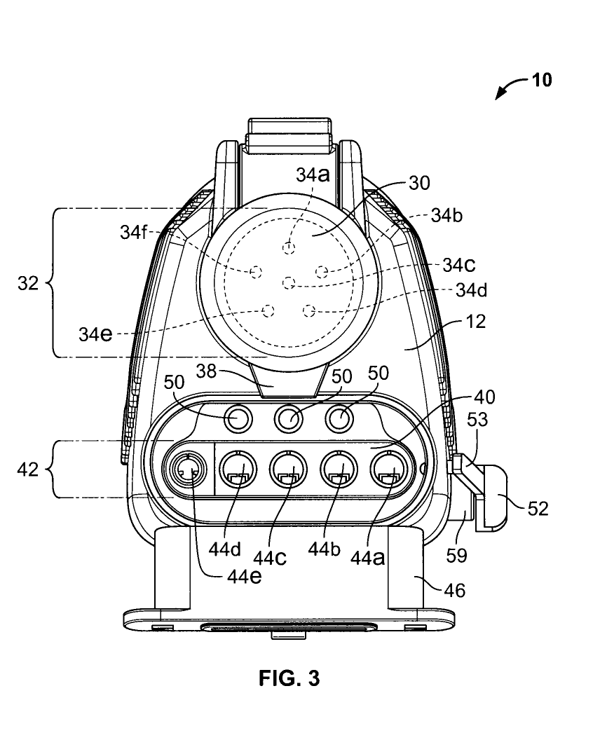

More specifically, the second set of terminals 32 may be a six-way terminal, an example of which is shown in FIGS. 3 and 11-12 as 6-way pin terminals, in which one terminal 34b may connect ground, a second terminal 34e may connect the left turn and stop control, a third terminal 34d may connect the right turn and stop control, a fourth terminal 34a may connect the tail light control, a fifth terminal 34c may connect the electric brake/auxiliary control circuit, and a sixth terminal 34f may connect an auxiliary/brake circuit to the towed vehicle.

Alternatively, the second set of terminals 32 may be a seven-way terminal (not shown) in which one terminal 34a may connect to ground, a second terminal 34b may connect the left turn and stop control, a third terminal 34c may connect the right turn and stop control, a fourth terminal 34d may connect the tail light control, a fifth terminal 34e may connect the electric brake control circuit, a sixth terminal 34f may connect the battery/auxiliary control, and a seventh terminal (not shown) may connect the backup/auxiliary control to the towed vehicle.

In yet another alternative embodiment, the second set of terminals 32 may be a five-way in which one terminal 34a may connect ground, a second terminal 34b may connect the left turn and stop control, a third terminal 34c may connect the right turn and stop control, a fourth terminal 34d may connect the tail light control, and a fifth terminal 34e may connect the electric brake control circuit to the towed vehicle. In this embodiment, the terminals 34a-34e may be arranged in a linear orientation (not shown), a generally circular arrangement or any other appropriate configuration. However, in this embodiment, the electric brake connection results in the deactivation of the electric brake and operation of a back-up light. This is useful for boat trailers that require to be backed down a ramp into the water. It should be understood, however, that many other variations may be used without departing from the present invention.

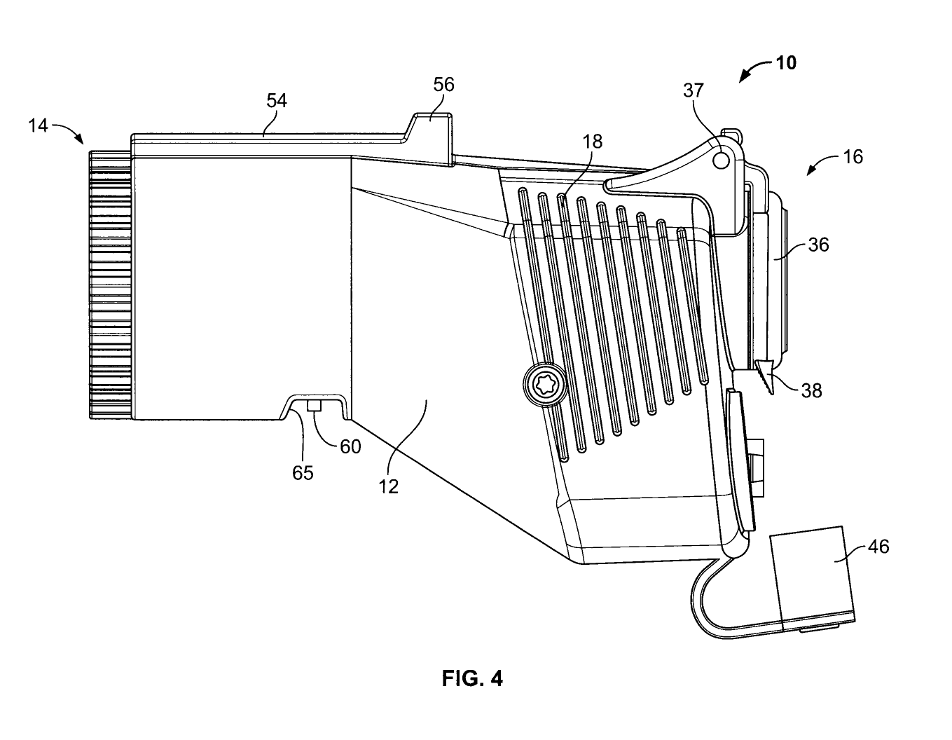

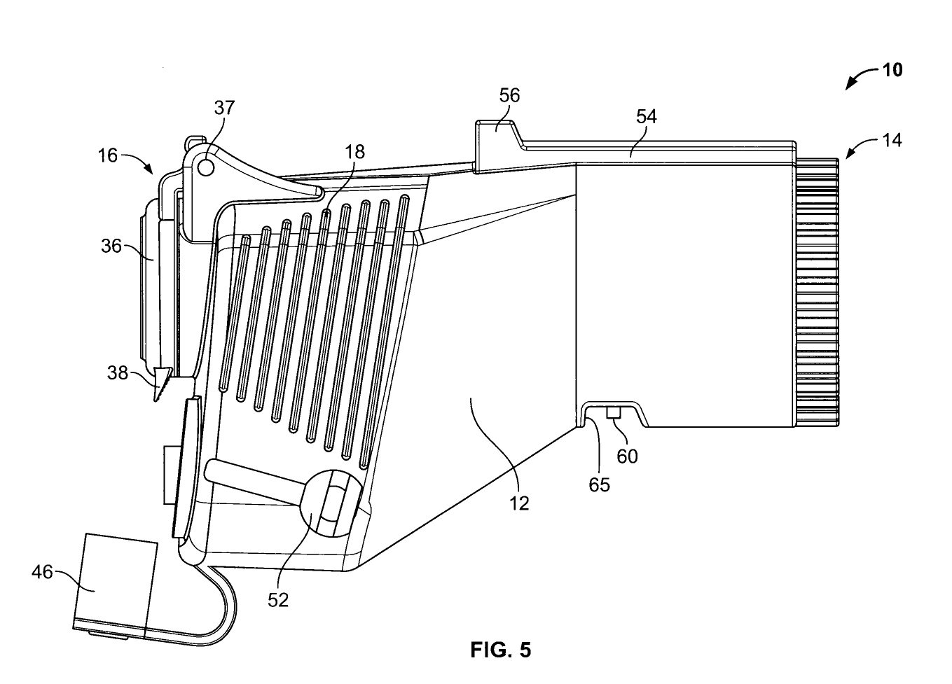

The pin adapter 10 may include a cover 36, an example of which is shown in FIGS. 1, 4 and 5, for the second interface 30. The cover 36 may be of any appropriate shape or size, such as a generally circular or rectangular shape, or any other appropriate shape. The cover 36 may be correspondingly shaped and sized to fully cover the second interface 30 and its second set of terminals 32. The cover 36 may be attached to the body 12 by any appropriate means, such as with a tether, by a hingedly connected mechanism, or by any other appropriate means. As shown in FIGS. 4 and 5, the cover 36 may be attached by a hinge 37, or alternatively be attached by a tether (not shown). In an alternative embodiment, the cover 36 may not be attached to the body 12, but may be completely removable therefrom. The cover 36 may protect the second set of terminals 32 and provide weather protection to the second interface 30. The cover 36 may include a tab 38. The tab 38 may aid the user in lifting the cover off of the second interface 30.

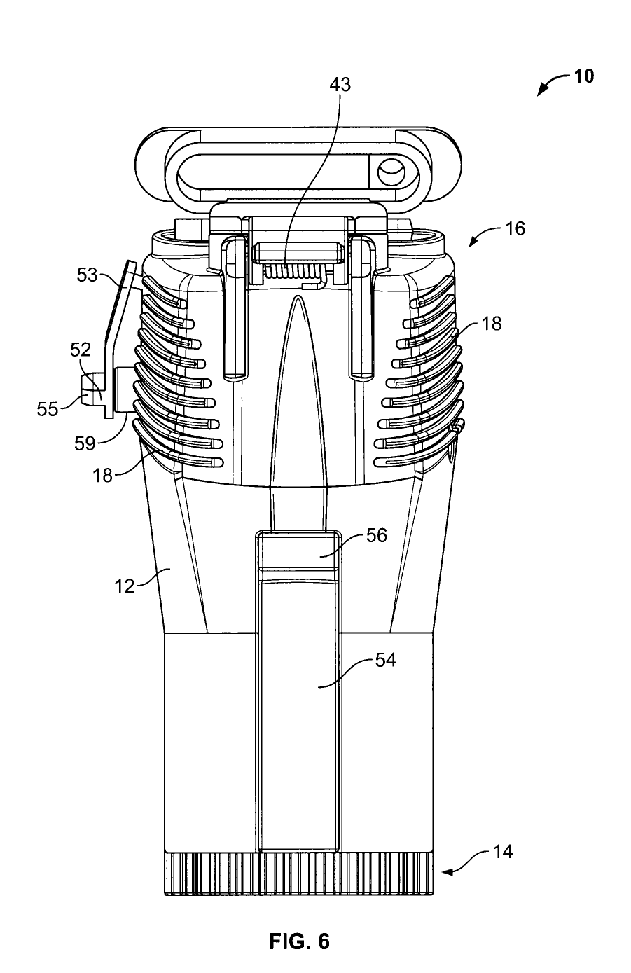

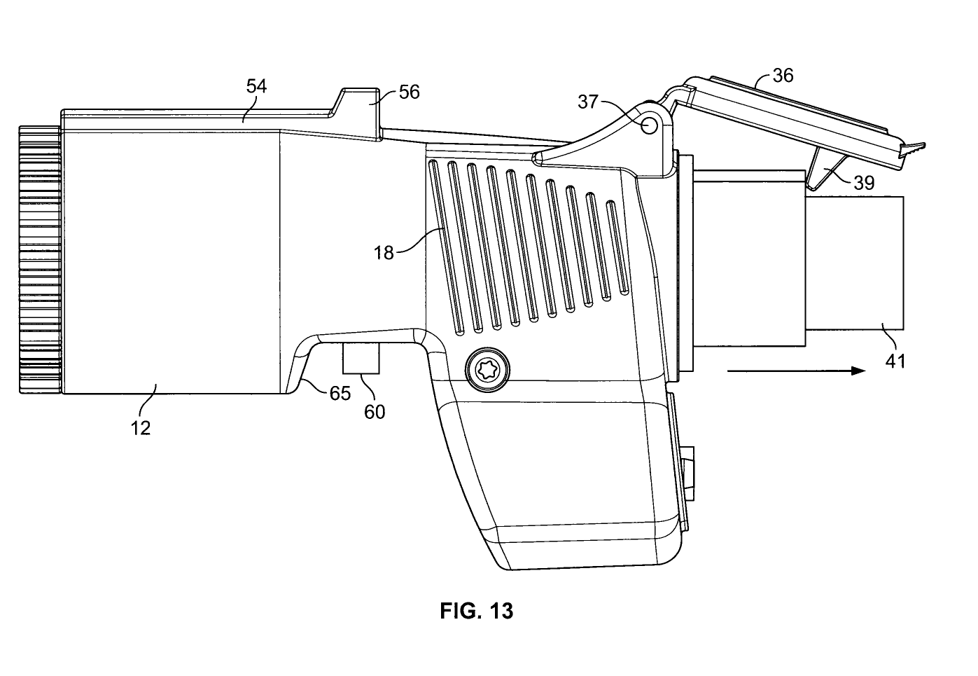

In an alternative embodiment shown in FIG. 13, the cover 36 may include a locking feature 39 such as a tab to help secure a corresponding mating plug 41 to the pin adapter 10. The mating plug 41 may, by way of a non-limiting example, be from a towed vehicle (not shown). The locking feature 39 may help prevent the mating plug 41 from being pulled out by the towed vehicle (not shown) while attached to the corresponding set of terminals. In this embodiment, the cover 36 may be biased toward the second set of terminals 32 to either keep the cover 36 closed or to help secure the mating plug 41 in place on the second set of terminals 32. More specifically, the biasing force of the cover 36 may force the locking tab 39 to engage with the mating plug 41 as shown in FIG. 13. As the locking tab 39 engages the mating plug 41, the biasing force of the cover 36 also biases the locking tab 39 toward the mating plug 41 helping to secure the mating plug 41 to the second set of terminals 32. In this embodiment, the biasing force may be applied by a spring 43, as shown in FIGS. 1 and 6, which may engage the cover 36 and the body 12 of the adapter 10 at the hinge 37. Alternatively, the locking feature 39 may be used to help secure a mating plug to any of the appropriate set of terminals, not just the second set of terminals 32.

The third electrical interface 40 may be located at any appropriate position on the adapter 10, such as at the second end 16. The third interface 40 may include a third set of terminals 42. The third set of terminals 42 may include at least one terminal 44, however, there may be any appropriate number of terminals 44, such as two, three, five, etc. The terminals 44 may be of any appropriate shape, size, or type. For example, the terminals 44 may be generally cylindrical in shape. The terminals 44 may be in any appropriate type of arrangement or configuration, such as in a generally linear arrangement or any other appropriate configuration. Each terminal 44 may correspond to a certain function, such as providing a signal for controlling the tail lights, left turn signal, right turn signal, brake lights, brake circuit, back-up/auxiliary, battery voltage, and the like from the corresponding master electrical system of the towing vehicle 11 to the subservient electrical system of the towed vehicle. This results in the user of the towing vehicle 11 only having to operate the function on the towing vehicle 11 to operate the corresponding function on the towed vehicle.

For example, the third set of terminals 42 may be a five-way terminal, such as that shown in FIGS. 3 and 11-12, in which one terminal 44e may connect ground, a second terminal 44c may connect the left turn and stop control, a third terminal 44b may connect the right turn and stop control, a fourth terminal 44d may connect the tail light control, and a fifth terminal 44a may connect the electric brake control circuit to the towed vehicle.

Alternatively, the third set of terminals 42 may be a four-way terminal in which one terminal 44e may connect ground, a second terminal 44c may connect the left turn and stop control, a third terminal 44b may connect the right turn and stop control, and a fourth terminal 44d may connect the tail light control to the towed vehicle. When the third set of terminals 42 is configured as a four-way terminal the fifth terminal 44a is absent. It should be understood, however, that many other variations may be used without departing from the present invention.

The third electrical interface 40 may optionally include a cover 46. The cover 46 may be of any appropriate shape or size, such as a generally circular, ovular or rectangular shape. The cover 46 may be correspondingly shaped and sized to fully cover the third electrical interface 40 and its third set of terminals 42. The cover 46 may be attached to the body 12 by any appropriate means, such as with a tether, by a hingedly connected mechanism, or by any other appropriate means. Alternatively, the cover 46 may be completely removable from the body 12. The cover 46 may protect the third set of terminals 42 and provide weather protection to the third electrical interface 40. It should be understood, however, that the cover 46 may not be included at all.

The pin adapter 10 may include at least one light-emitting diode (LED) 50, which is shown in FIGS. 3 and 11-12. There may be any appropriate number of LEDs 50, such as two, three, four, etc. The LEDs 50 may be used for any appropriate purpose, such as ground effects or an integrated circuit tester. The integrated circuit tester with LEDs 50 may monitor the continuity of the circuits. In particular, the LEDs 50 will continuously be illuminated if there is continuity of the circuit. This, therefore, may allow the user to determine if the pin adapter 10 is installed effectively and that the connections on the pin adapter 10 have not come undone or disconnected. The LEDs 50 may be of any appropriate color, such as blue, clear, red, etc., or any combination of colors.

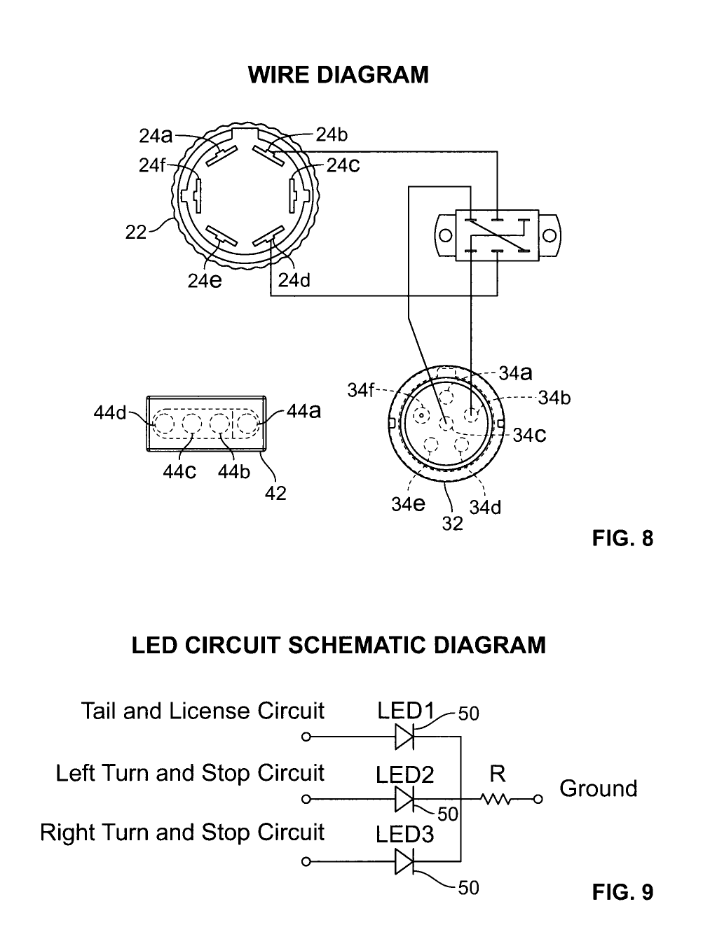

By way of a non-limiting example an LED circuit schematic diagram is shown in FIG. 9. In this diagram, three LEDs 50 are shown, but are not limited to three. Any number of LEDs 50 may be used. In the circuit diagram, the LEDs 50 may be connected to a single resistor R that is grounded. It should be understood that each LED circuit may utilize an appropriate number of resistors R, including, without limitation utilizing a single resistor R as shown in FIG. 9. The three LEDs 50 comprise a tail and/or license circuit, a left turn and stop circuit, and a right turn and stop circuit.

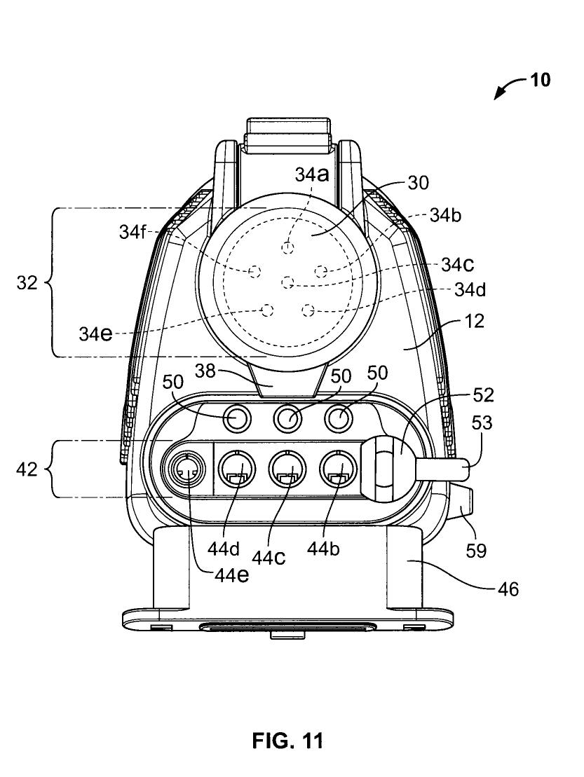

As stated above, third electrical interface 40 may have third set of terminals 42 configured as a five-way terminal with five terminals 44a-e, such as shown in FIGS. 3 and 11-12. The pin adapter 10 may also include a fifth terminal cover 52 shown in FIGS. 2, 3, 5-7 and 11-12. The fifth terminal cover 52 may be of any appropriate shape or size, such as a generally circular or rectangular shape. The fifth terminal cover 52 may be correspondingly shaped and sized to fully cover and encase the fifth terminal 44a, as shown in FIG. 11. The fifth terminal cover 52 may be attached to the body 12 by any appropriate means, such as with a tether, by a hingedly connected mechanism, or by any other appropriate means. More specifically, as shown in FIGS. 6 and 11, the fifth terminal cover 52 is attached via a second portion 53 such as a tethered portion, which permits the fifth terminal cover 52 to be moved between engagement and disengagement with fifth terminal 44a, without separating from the pin adapter 10. Alternatively, the fifth terminal cover 52 may not be permanently attached to the body 12, but may be completely removable therefrom. The fifth terminal cover 52 may selectively protect the fifth terminal 44a and provide weather protection to the fifth terminal 44a. For example, the fifth terminal cover 52 may be used to cover and protect fifth terminal 44a when a four-way connector is connected with terminals 44b-e. The fifth terminal cover 52 then covers the unused fifth terminal 44a protecting it. Cover 46 may then be used to cover terminals 44a-e when no connector is connected to the third electrical interface 40.

In one embodiment, the fifth terminal cover 52 may attach to a cradle/holder such as a female socket like member 59, which may be formed in the body 12 of the pin adapter 10. In this embodiment, a portion of the fifth terminal cover 52 may be a male member 55. The male member 55 may be engageable with the socket like member 59 to secure it in a storage position. Alternatively, any kind of cradle may be used to secure the fifth terminal cover 52 to an appropriate location on the body 12 of the pin adapter 10, such as the side portion as shown in FIGS. 6 and 11-12.

When the user needs to use the fifth terminal cover 52 to cover the fifth terminal 44a such as when the pin adapter 10 is being used as a four-way adapter and the fifth terminal 44a is not being used, the user may pull the male member 55 from the cradle/socket like member 59. The fifth terminal cover 52 may then be rotated such that the male member 55 of the fifth terminal cover 52 engages the fifth terminal 44a to secure the fifth terminal cover 52 over the fifth terminal 44a. This may protect the fifth terminal 44a from the elements.

As further shown in FIGS. 6 and 11, the second portion 53 of the fifth terminal cover 52 may be tethered to a portion of the body 12 of the pin adapter 10. In this embodiment, the body 12 may include a slot (not shown). The second portion 53 of the fifth terminal cover 52 may be attached to the body 12 within the slot such that the second portion 53 may be inserted and stored within the slot to keep it out of the way. Although, the second portion 53 is shown as being tethered, it may be secured to the body 12 in any suitable manner. Alternatively, the second portion 53 may remain free from the body 12 and not be attached at all.

Further, the fifth terminal cover 52 may be secured to the body 12 of the pin adapter 10 in a compact fashion to keep it away from interfering with the functionality of any other portion of the pin adapter 10. For example, the body 12 may include a recess (not shown) where the male member 55 may be attached to the body 12. This may protect the fifth terminal cover 52 from interfering with other components of the pin adapter 10.

The pin adapter 10 may include an alignment member 54. The alignment member 54 may be of any appropriate shape or size, such as a generally square, rectangular, or circular shape. The alignment member 54 may be located at any appropriate position on the adapter 10, such as along an approximate centerline of the body 12. The alignment member 54 may be slightly raised from the surface of the body 12. The alignment member 54 may aid in alignment of the adapter 10. For example, the alignment member 54 may help with proper alignment when coupling the first end 14 with the master electrical system of the towing vehicle 11. The alignment member 54 may cooperate with a correspondingly shaped and sized key-type mechanism of the electrical system that may be provided at the towing vehicle.

The pin adapter 10 may include a stop 56 shown in FIGS. 1 and 4-6. The stop 56 may be of any appropriate shape or size, such as a generally square, rectangular, or circular shape. The stop 56 may be located at any appropriate position on the adapter 10, such as at the approximate center of the body 12. The stop 56 may be at a raised position from the surface of the body 12. The stop 56 may contact a portion of the towing vehicle 11 or trailer and thereby prevent any further movement/insertion of the pin adapter 10. The pin adapter 10 may also include any other appropriate features, such as a back-up alarm (not shown). The back-up alarm makes and audible noise when the towing vehicle 11 and/or towed vehicle are/is in reverse and/or moving backwards.

The pin adapter 10 may include an actuator, such as a switch 60, which is shown in FIGS. 4-5 and 7-7A. The switch 60 may be of any appropriate shape or size, such as a generally square, rectangular, or circular shape. The switch 60 may be located at any appropriate position on the adapter 10, such as at an approximate center of the underside of the body 12. By way of a non-limiting example, the switch 60 may be positioned on the body 12 perpendicular to the first electrical interface 20.

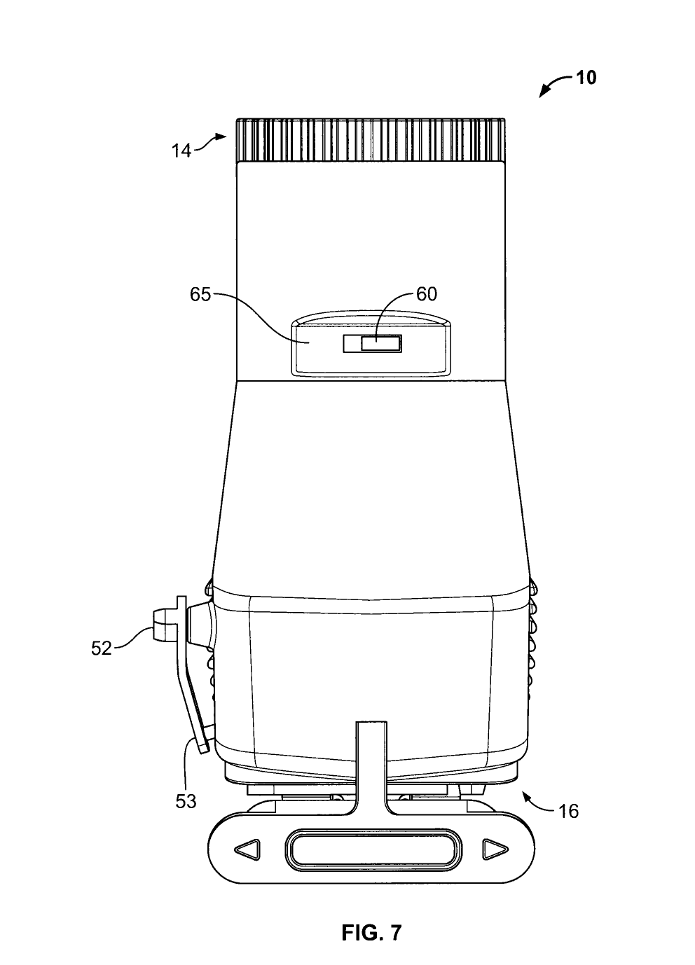

The switch 60 may move laterally across the body 12 from a first position, shown in FIG. 7, to a second position, shown in FIG. 7A, in operation thereof. The switch 60 may be positioned on the body 12 in a recess 65 of the body 12 in an effort to help prevent the switch 60 from being inadvertently manipulated between the first and second positions. The recess 65 may allow the switch 60 to be below or at the approximately same level as the body 12 adjacent the switch 60.

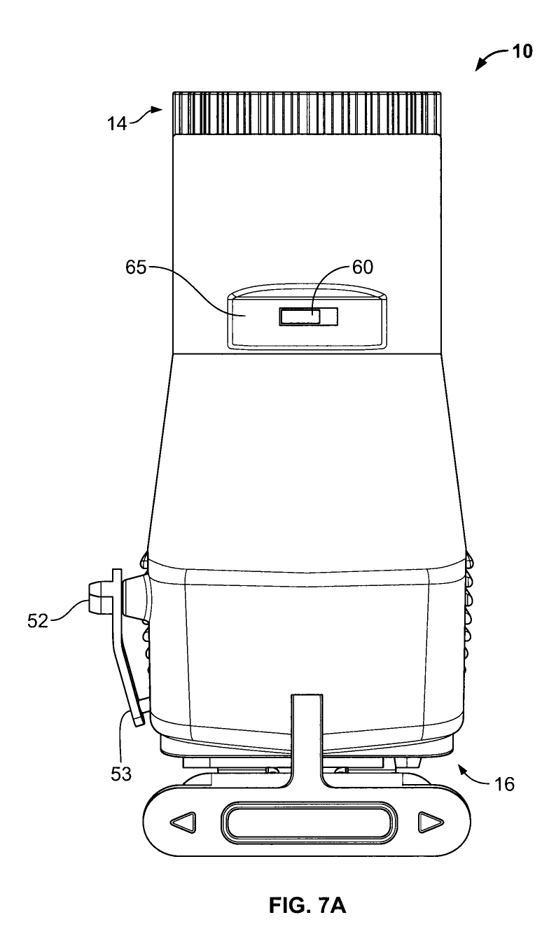

The switch 60 may be utilized to allow the consumer to manually switch to alternate the auxiliary pin 24b and electric brakes pin 24d, as is shown on FIG. 8, between two universal standards, such as between providing an auxiliary 12 volt signal and an electric brake signal. In particular, the switch 60 may permit an electrical interface to be manipulated to an alternative electrical set up. The switch 60 may change the applicable functionality of a particular terminal. In prior art adapters, if the wrong adapter is used the towed vehicle will not function properly. For example, if the terminal that is supposed to connect the electric brake is mistakenly used to connect the 12 V battery control instead, the electric brakes will not function properly. In this situation, the electric brakes may lock and require the adapter be removed to release the brakes. Additionally, the adapter may need to be taken apart and re-wired to have the proper terminal connections made.

In an exemplary embodiment, the switch 60 may take a seven-way terminal on a master electrical system and convert it to a 6-way terminal on a subservient electrical system. For example, a seven-way terminal on a master electrical system, such as that of a towing vehicle 11, may be capable of operating an electric brake and an auxiliary component (using a 12 V battery signal) of a towed vehicle if the towed vehicle also had a seven-way terminal. The switch 60 on the adapter 10, however, may convert the seven-way terminal on the master electrical system to a six-way terminal of a subservient system, such as a towed vehicle, to operate the auxiliary component and the electric brake.

Alternatively, the switch 60 may take a six-way terminal on a master electrical system and convert it to a different configuration of a six-way terminal on a subservient electrical system. For example, if the terminal that is supposed to connect the electric brake is configured to be used to connect the 12 V battery control instead, the switch 60 can be actuated from the first position to the second position—thereby altering the adapter 10 configuration. Upon actuation of the switch 60 the electrical connection of the terminals from the wrong function to the proper function is changed. A non-limiting example of this may be shown in more detail in FIG. 8, wherein the second terminal 24b and fourth terminal 24d of the first set of terminals 22 are connected to the circuit along with a second terminal 34b and third terminal 34c of the second set of terminals 32 via the alternating switch 60. In this embodiment, when the switch 60 is actuated the terminal that connects the electric brakes is now properly connected and the electric brakes will function. Specifically, the switch 60 may alternate functions between pin 34b and pin 34c. By way of a non-limiting example when the switch 60 is in the first position the pin 34c (which may be referred to as a central pin) may have a brake control function and accordingly pin 34b may have an auxiliary control function. When the switch 60 is actuated to the second position the functions on these two pins may be switched such that the pin 34c may now have auxiliary control function and the pin 34b may have brake control function. It should be understood, however, that the switch 60 is not limited to changing the connection of just the electric brakes and the 12 V battery control. The switch 60 may be configured to be capable of accomplishing the change for any of the applicable functions, as desired.

While the pin adapter 10 may have been shown and described as utilizing certain types of terminals or configurations of terminals, the pin adapter 10 should not be limited to that shown and described herein. For example, the pin adapter 10 may provide for a seven-way to six-way adapter, a seven-way to four-flat adapter, etc.

The pin adapter 10 may be connected to the electrical system of the towing vehicle 11, whereby the adapter 10 may be properly integrated into the master electrical system of the towing vehicle 11. When it is desired to tow a trailer, the subservient electrical system of the towed vehicle may be connected to that of the towing vehicle 11 through the pin adapter 10. Connecting the electrical systems of the towing 11 and towed vehicles through the pin adapter 10 may serve to electrically interconnect the electrical systems, without requiring any modification of the pin adapter 10.

For example, the first interface 20 may cooperate with the electrical connecter on the towing vehicle 11 so as to permit an electrical connection through the pin adapter 10. The second or third interfaces 30, 40 may cooperate with the electrical connector on the towed vehicle so as to electrically connect the towed vehicle with the subservient electrical system of the towing vehicle 11 via the pin adapter 10.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The claims as follows are intended to include all modifications and alterations insofar as they come within the scope of the claims or the equivalent thereof.

Having thus described the invention, we claim:

1. A pin adapter for attaching an electrical system of a towing vehicle with an electrical system of a towed vehicle, the pin adapter comprising:
a body, the body comprising:
a first electrical interface capable of electrically engaging the electrical system of the towing vehicle;
a second electrical interface capable of electrically engaging the electrical system of the towed vehicle, wherein the second electrical interface includes a plurality of terminals; and
a cover attached to the body, the cover capable of encasing only one of the plurality of terminals of the second electrical interface.

2. The pin adapter of claim 1, wherein the body further comprises a third electrical interface capable of electrically engaging the electrical system of the towed vehicle.

3. The pin adapter of claim 2, wherein the third electrical interface comprises at least one of a 12-V adapter and a six-pin adapter.

4. The pin adapter of claim 2, wherein the first and second electrical interfaces are on opposite sides of the body.

5. The pin adapter of claim 4, wherein the third electrical interface is adjacent the second electrical interface on the body.

6. The pin adapter of claim 1, wherein the first electrical interface comprises a seven-blade interface.

7. The pin adapter of claim 6, wherein the second electrical interface comprises at least one of a four-pin adapter and a five-pin adapter.

8. The pin adapter of claim 1, wherein the second electrical interface further includes an integrated circuit tester comprising a plurality of light-emitting diodes.

9. A pin adapter comprising:
a body having a first electrical interface having a plurality of terminals;
a first cover capable of encasing an entirety of the plurality terminals; and
a second cover capable of encasing only a single one of the plurality of terminals.

10. The pin adapter of claim 9, wherein the body further includes a second electrical interface that is different than the first electrical interface.

11. The pin adapter of claim 10, wherein the second electrical interface electrically engages a towed vehicle and the first electrical interface electrically engages a towing vehicle.

12. The pin adapter of claim 11, further comprising:
first and second electrical interconnections between the first and second electrical interfaces, wherein the first and second electrical interconnections are different; and
a switch capable of selectively changing the first electrical interconnection to the second electrical interconnection.

13. The pin adapter of claim 10, wherein the body further includes a switch capable of changing an electrical interconnection between the first electrical interface and the second electrical interface.

14. The pin adapter of claim 13, wherein the switch changes a terminal on the second electrical interface from an auxiliary connection to an electrical brake connection.

15. The pin adapter of claim 10, wherein the second electrical interface includes an integrated circuit tester.

16. A pin adapter capable of attaching a master electrical system of a towing vehicle having a first electrical configuration with a subservient electrical system of a towed vehicle having a second electrical configuration, the pin adapter comprising:
a first electrical interface electrically engaging the master electrical system and a second electrical interface electrically engaging the subservient electrical system;
at least first and second electrical interconnections between the first and second electrical interfaces, wherein the at least first and second electrical interconnections are different; and
an actuator capable of selectively changing the first electrical interconnection to the second electrical interconnection.

17. The pin adapter of claim 16, wherein the actuator comprises a manually operated switch.

18. The pin adapter of claim 16, wherein selectively changing from the first electrical interconnection to the second electrical interconnection results in changing of at least one function of either of the first or second electrical interfaces.

19. The pin adapter of claim 16, wherein selectively changing from the first electrical interconnection to the second electrical interconnection results in a function from the master electrical system matching a corresponding function of the subservient electrical system.

20. The pin adapter of claim 16, wherein actuating the actuator changes a terminal of the second electrical interface from an auxiliary function to an electrical brake function.
